(19) United States
(12) Patent Application Publication
(10) Pub. No.: US 2026/0275742 A1
(43) Pub. Date: Sep. 17, 2026

(54) DEBRIS BASKET AND WATER SURFACE CLEANING ROBOT

(71) Applicant: Shenzhen Maining Innovation Technology Co., Ltd., Shenzhen (CN)

(72) Inventor: Huifeng HUANG, Shenzhen (CN)

(73) Assignee: Shenzhen Maining Innovation Technology Co., Ltd., Shenzhen (CN)

(21) Appl. No.: 19/670,264

(22) Filed: May 7, 2026

(30) Foreign Application Priority Data
Mar. 25, 2026 (CN) 202620377979.2

(51) Int. Cl. E04H 4/12; A46B 13/00; A46B 13/02; C02F 1/40; C02F 103/42

(52) U.S. Cl. CPC E04H 4/1263; C02F 1/40; A46B 13/001; A46B 13/02; A46B 2200/3073; C02F 2103/42; C02F 2201/008

(57) ABSTRACT

A debris basket includes a debris basket body provided with a debris collection cavity. The debris basket body is provided with a water inlet at a first end and water outlets at an opposite second end. The debris basket body is provided with a plurality of accommodating spaces recessed toward the debris collection cavity. The accommodating spaces are configured to accommodate a driving mechanism. The water inlet, the debris collection cavity, and the water outlets form a debris collecting water flow channel. The accommodating spaces form a propelling water flow channel. The debris collecting water flow channel and the propelling water flow channel are isolated from each other. The present application further provides a water surface cleaning robot including the debris basket.

### CROSS-REFERENCE TO RELATED APPLICATIONS

This application claims priority to Chinese Patent Application No. 202620377979.2 with a filing date of Mar. 25, 2026. The content of the aforementioned application, including any intervening amendments thereto, is incorporated herein by reference.

### TECHNICAL FIELD

The present application belongs to the technical field of water surface cleaning robots, and particularly relates to a debris basket and a water surface cleaning robot.

### BACKGROUND

An existing water surface cleaning robot for a swimming pool typically uses a propeller and a turbine to generate a water flow, which serves to propel the robot across the water surface and to draw floating debris into a debris collection device. In such a structure, the water flow for propelling and the water flow for debris collection often share the same water path or are interconnected.

However, during actual use, the above-mentioned structure has particular drawbacks. Since floating debris on the water surface of the swimming pool enters the propelling area along with the water flow, it may easily become entangled around the propeller or enter the propelling channel, leading to increased propelling resistance, and even causing problems such as propeller jamming and motor overload. Moreover, the accumulation of debris affects the stability of water intake, causing fluctuations in propelling force, which in turn affects the operational stability and cleaning efficiency of the robot.

Furthermore, the mutual interference between the propelling system and the debris collection system also results in increased energy consumption and noise, as well as higher maintenance frequency and usage costs. These impede the long-term stable operation of the water surface cleaning robot for the swimming pool.

Therefore, further improvements are still needed in the prior art to enhance the operational reliability and overall performance of the water surface cleaning robot for the swimming pool.

### SUMMARY OF PRESENT DISCLOSURE

An objective of the present application is to provide a debris basket and a water surface cleaning robot. By providing the debris basket, the propelling water flow and the debris collecting water flow can be made independent of each other, thereby avoiding mutual interference between the propelling system and the debris collection system, and thus improving the operational reliability and overall performance of the water surface cleaning robot for a swimming pool.

To achieve the above objective, a first technical solution adopted by the present application is as follows: A debris basket, applicable to a water surface cleaning robot and including:
a debris basket body provided with a debris collection cavity for accommodating debris, where a first end of the debris basket body is provided with a water inlet communicating with the debris collection cavity, and a second end of the debris basket body opposite to the first end is provided with a plurality of water outlets communicating with the debris collection cavity;
the debris basket body is provided with a plurality of accommodating spaces recessed toward the debris collection cavity; the accommodating spaces are located on two sides of the water outlets and are configured to accommodate a driving mechanism of the water surface cleaning robot;
the water inlet, the debris collection cavity, and the water outlets form a debris collecting water flow channel; the accommodating spaces form a propelling water flow channel; and the debris collecting water flow channel and the propelling water flow channel are isolated from each other.

Further, the debris basket body is provided, on two sides of the water inlet, with flanges extending outwards obliquely.

Further, the debris basket body is provided, on a bottom of the water inlet, with a scoop extending obliquely toward a water surface.

Further, the debris basket further includes a rolling brush that is rotatably connected within the debris collection cavity and located above the water inlet.

Further, the debris basket further includes a handle that is disposed within the debris collection cavity.

Further, a plurality of drainage holes are formed in a bottom of the debris collection cavity.

The present application further provides a second technical solution: A debris basket is applicable to a water surface cleaning robot and includes: a debris basket body provided with a debris collection cavity for accommodating debris, where a first end of the debris basket body is provided with a water inlet communicating with the debris collection cavity, and a second end of the debris basket body opposite to the first end is provided with a plurality of water outlets communicating with the debris collection cavity;
the debris basket body is divided into a first segment and a second segment along a direction from the water inlet to the water outlets; the debris collection cavity has a larger cross-sectional area at the first segment than at the second segment such that accommodating spaces that are configured to accommodate a driving mechanism of the water surface cleaning robot are formed on two sides of the second segment;
the water inlet, the debris collection cavity, and the water outlets form a debris collecting water flow channel; the accommodating spaces form a propelling water flow channel; and the debris collecting water flow channel and the propelling water flow channel are isolated from each other.

Further, a transition segment is further provided between the first segment and the second segment; and along the direction from the water inlet to the water outlets, the debris collection cavity has a gradually decreasing cross-sectional area at the transition segment.

The present application further provides a third technical solution: A water surface cleaning robot includes a robot body and the debris basket in the first technical solution, where a mounting cavity is formed within the robot body, and the debris basket is detachably mounted within the mounting cavity.

Further, the water surface cleaning robot further includes a driving mechanism that includes a driving motor and a propeller, where an output shaft of the driving motor is connected to the propeller;
after the debris basket is mounted within the mounting cavity, the driving mechanism is located within the accommodating spaces; and the output shaft of the driving motor is higher than a bottom surface of the debris basket body in a height direction.

The present application has the following beneficial effects: 1, by separating two driving mechanisms with the debris basket body, the present application can avoid mutual water flow interference between the two driving mechanisms.
2, by separating the two driving mechanisms with the debris basket body, the present application achieves isolation between the debris collecting water flow channel and the propelling water flow channel, thereby ensuring the operational stability of the driving mechanisms and improving propelling efficiency. Meanwhile, the problem of debris entanglement around the propellers is avoided, and the operational reliability of the robot is improved.
3, by arranging the driving mechanisms on two sides respectively in isolated accommodating spaces, the present application can enable the debris basket body to block the water flow interference that the driving mechanisms on two sides may cause to each other during turning, allowing for more flexible turning and more precise control of the robot.
4, the debris basket of the present application can fully utilize the dimension of the water surface cleaning robot in the length direction, thereby increasing the debris collection capacity of the debris basket.

### BRIEF DESCRIPTION OF THE DRAWINGS

FIG. 1 is a schematic structural diagram showing a bottom surface of a debris basket according to Embodiment 1 of the present disclosure;

FIG. 2 is a schematic structural diagram showing a front surface of the debris basket according to Embodiment 1 of the present disclosure;

FIG. 3 is a view of the debris basket as seen from the front end toward the rear end according to Embodiment 1 of the present disclosure;

FIG. 4 is a side cross-sectional view showing the debris basket according to Embodiment 1 of the present disclosure;

FIG. 5 is a schematic diagram showing a cooperative relationship between the debris basket and driving mechanisms according to Embodiment 1 of the present disclosure;

FIG. 6 is a schematic structural diagram showing a debris basket according to Embodiment 2 of the present disclosure;

FIG. 7 is an exploded structural diagram showing a water surface cleaning robot according to Embodiment 3 of the present disclosure;

FIG. 8 is a schematic diagram showing water flow of the water surface cleaning robot according to Embodiment 3 of the present disclosure; and

FIG. 9 is a schematic diagram showing swirling water flow generated by the driving mechanisms on two sides according to Embodiment 3 of the present disclosure.

List of Reference Numerals: 100—debris basket; 1—debris basket body; 11—debris collection cavity; 12—accommodating space; 13—scoop; 14—flange; 15—water outlet; 16—drainage hole; 17—first segment; 18—transition segment; 19—second segment; 2—water inlet; 3—handle; 4—rolling brush; 5—driving motor; 6—propeller; 7—driving mechanism;
200—robot body; 2001—mounting cavity; and
1000—water surface cleaning robot.

### DETAILED DESCRIPTION OF THE EMBODIMENTS

The present application is further described in detail below with reference to drawings and embodiments, but it should not be used as a basis for limiting the present application.

### Embodiment 1

This embodiment provides a debris basket 100, applicable to a water surface cleaning robot 1000 and configured to collect and store debris on the water surface while driving the self-propelled water surface cleaning robot 1000 to move forward.

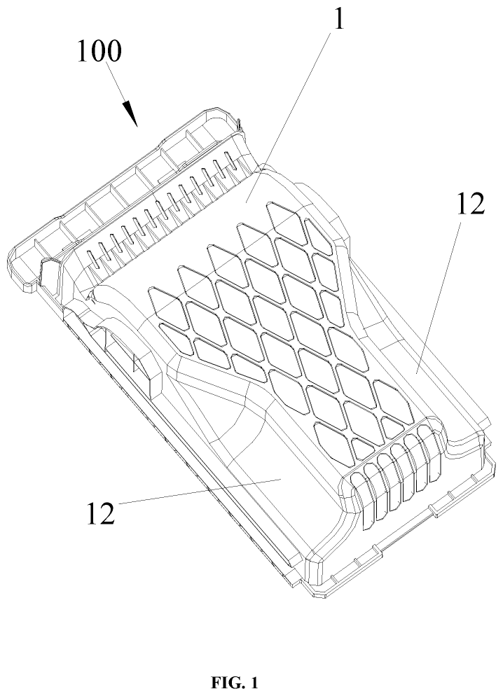

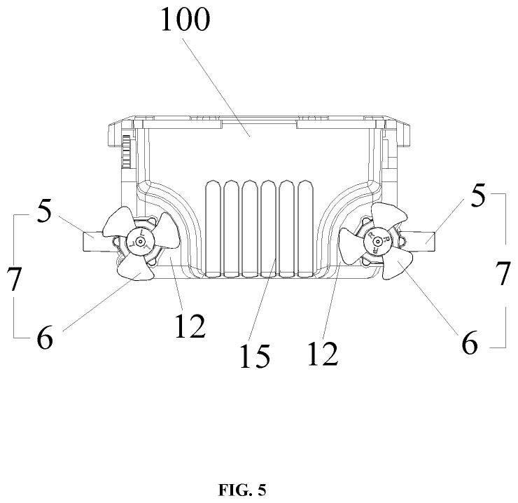

The structure of the debris basket 100, as shown in FIG. 1 and FIG. 5, includes a debris basket body 1 provided with a debris collection cavity 11 for accommodating debris. A first end of the debris basket body 1 is provided with a water inlet 2, and the water inlet 2 is designed as an opening to facilitate smooth entry of debris into the debris collection cavity 11. A second end of the debris basket body 1 opposite to the water inlet 2 is provided with water outlets 15.

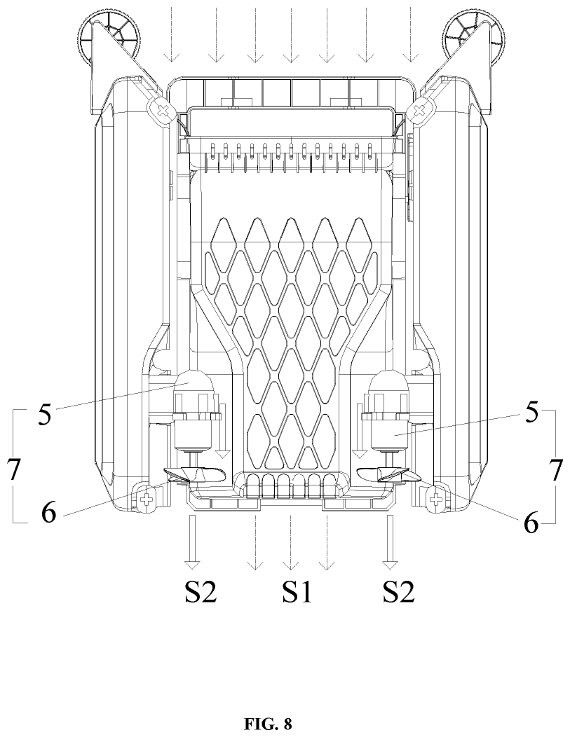

With the above design, as shown in FIG. 8, during the process in which debris on the water surface enters the debris collection cavity 11 along with the water flow through the water inlet 2, the debris on the water surface is blocked by the debris basket body and remains in the debris collection cavity 11, while the remaining water flows out through the water outlets 15. Thus, the water inlet 2, the debris collection cavity 11, and the water outlets 15 form a debris collecting water flow channel S1, as indicated by the thin arrows in FIG. 8.

As shown in FIG. 1 and FIG. 5, the debris basket body 1 is provided with a plurality of accommodating spaces 12 recessed toward the debris collection cavity 11. The accommodating spaces 12 are located on two sides of the water outlets 15 and are configured to accommodate a driving mechanism 7 of the water surface cleaning robot 1000. The driving mechanism 7 generates a propelling water flow within the accommodating spaces 12 to propel the water surface cleaning robot forward. Thus, the accommodating spaces 12 may form a propelling water flow channel S2, as indicated by the wide arrows in FIG. 8.

The propelling water flow channel S2 and the debris collecting water flow channel S1 are isolated from each other, and independent without interfering with each other. Therefore, problems such as leaves, hair, plastics, etc., being directly sucked into the accommodating spaces 12 and causing jamming or damage to the driving mechanism 7 can be avoided. Furthermore, it can be further guaranteed that the propelling system is more stable and controllable, and that the propelling water flow channel exhibits a constant flow rate, stable thrust, and better linearity.

Further, a plurality of drainage holes 16 are formed in a bottom of the debris collection cavity 11. It should be noted that, in order to prevent small debris from flowing out through the drainage holes 16 or the water outlets 15, a filter mesh is employed to cover the drainage holes 16 and the water outlets 15.

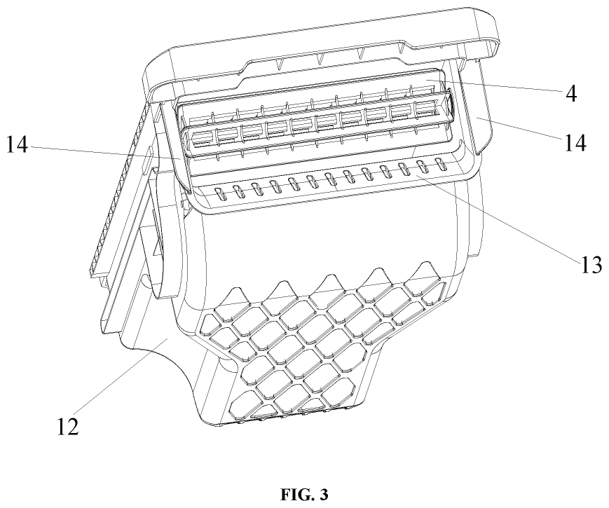

As shown in FIG. 3, the debris basket body 1 is provided, on left and right sides of the water inlet 2, with flanges 14 extending outwards obliquely. The flanges can allow debris to better enter the debris collection cavity 11 while reducing water flow that could interfere with the driving mechanism 7 when the water surface cleaning robot 1000 moves forward.

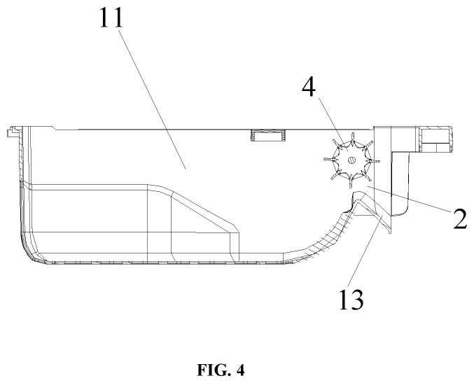

Further, as shown in FIG. 3 and FIG. 4, the debris basket body 1 is further provided, on a bottom of the water inlet 2, with a scoop 13 extending obliquely downwards, i.e., below the water surface. The scoop 13 is configured to lift up some debris partially submerged below the water surface (e.g., a leaf blade floating on the water surface while its petiole is submerged), allowing it to enter the debris collection cavity 11 more smoothly.

With continued reference to FIG. 3 and FIG. 4, a rolling brush 4 is further disposed on an inner side of the water inlet 2. The rolling brush 4 is provided with a plurality of blades (not shown in the figures). The rolling brush 4 is driven by a motor to rotate and thus can sweep water and floating debris or litter in front of the water inlet 2 into the debris collection cavity 11 of the debris basket 100, thereby improving the water surface cleaning efficiency.

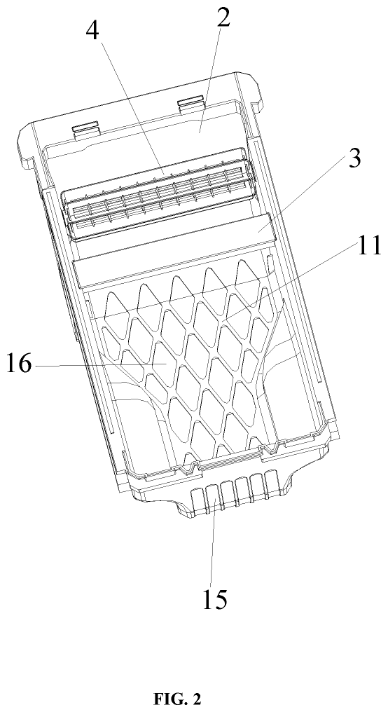

As shown in FIG. 2, the debris basket body is further provided with a handle 3. The handle 3 is located above the debris collection cavity 11, facilitating the user in lifting the debris basket 100 to empty debris.

### Embodiment 2

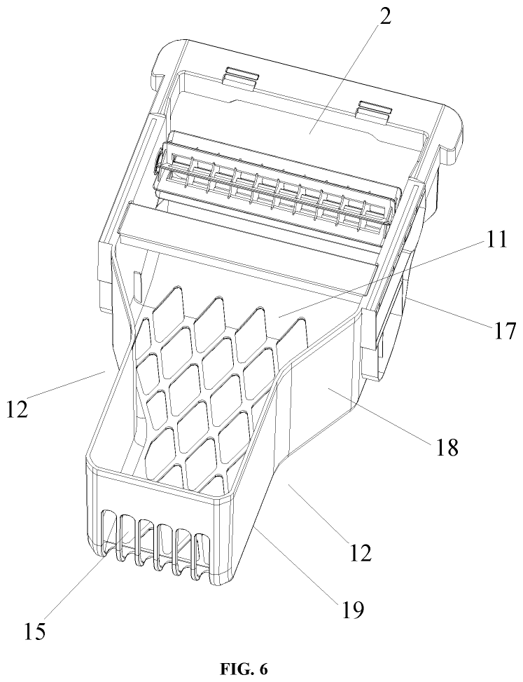

The difference between this embodiment and Embodiment 1 lies in the different arrangement of the accommodating spaces 12. As shown in FIG. 6, in this embodiment, the debris basket body 1 is divided into a first segment 17 and a second segment 19 along a direction from the water inlet 2 to the water outlets 15. The debris collection cavity 11 has a larger cross-sectional area at the first segment 17 than at the second segment 19 such that accommodating spaces 12 are formed on two sides of the second segment 19. The accommodating spaces 12 are configured to accommodate the driving mechanism 7 of the water surface cleaning robot 1000.

Further, a transition segment 18 is further provided between the first segment 17 and the second segment 19; and along the direction from the water inlet 2 to the water outlets 15, the debris collection cavity 11 has a gradually decreasing cross-sectional area at the transition segment 18.

### Embodiment 3

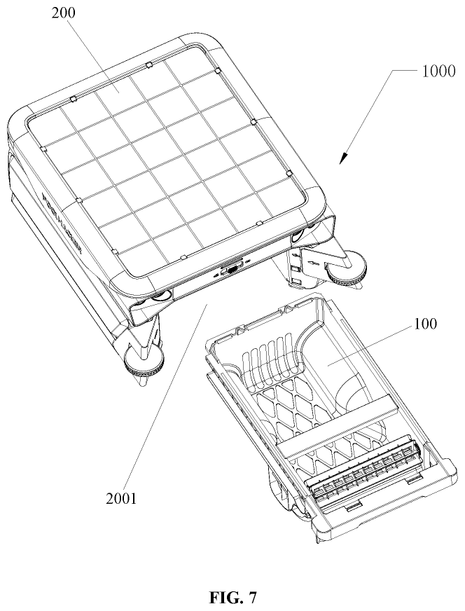

As shown in FIG. 7, the present application further provides a water surface cleaning robot 1000, including a robot body 200 and the debris basket 100 of Embodiment 1. A mounting cavity 2001 is formed within the robot body 200, and the debris basket 100 is detachably mounted within the mounting cavity 2001.

Driving mechanisms 7 are respectively disposed on two opposite sides of the mounting cavity 2001 of the robot body 200. Each driving mechanism 7 includes a driving motor 5 and a propeller 6, and an output shaft of the driving motor 5 is connected to the propeller 6.

After the debris basket 100 is mounted in the mounting cavity 2001, the driving mechanisms 7 are located within the accommodating spaces 12, and the output shaft of each driving motor 5 is higher than a bottom surface of the debris basket body 1 in the height direction.

The driving motor 5 drives the propeller 6 to rotate, generating forward thrust in the water to propel the water surface cleaning robot 1000 forward on the water surface.

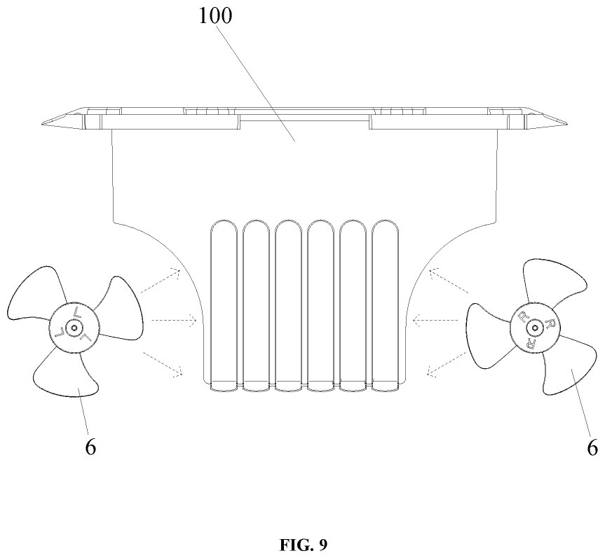

As shown in FIG. 9, by separating the two driving mechanisms 7 with the debris basket body 1, the present application can avoid mutual water flow interference between the two driving mechanisms 7. It will be understood that whether the water surface cleaning robot 1000 is moving straight or turning, the debris basket body 1 can block water flow interference between the propellers 6. When the water surface cleaning robot 1000 is moving straight, the two propellers 6 generate relatively strong lateral water flows, and the debris basket body 1 can block the lateral water flow interference between the two propellers 6, thereby ensuring that the driving motors 5 can operate smoothly with low power consumption and improving the operational reliability of the water surface cleaning robot 1000.

When the water surface cleaning robot 1000 needs to turn, one driving motor 5 rotates forward while the other driving motor 5 rotates reversely, and there is a rotational speed difference between them. Without the debris basket body 1, the lateral water flows generated by the rotating propellers 6 toward each other would affect the rotation of the propeller 6 with a lower rotational speed, causing it to rotate very slowly or even stop, thereby preventing the water surface device from turning properly. To solve this technical problem, the present application adopts a further optimized design: in the vertical direction, the output shaft of the driving motor 5 is higher than the bottom surface of the debris basket body 1. Thus, the two propellers 6 are separated by the debris basket body 1, so that the lateral water flow interference between the two propellers 6 can be blocked, ensuring that the water surface cleaning device turns properly.

The above embodiments are merely intended to describe the technical solutions of the present application, rather than to limit the present application. Although the present application is described in detail with reference to the above embodiments, a person of ordinary skill in the art may still make modifications or equivalent substitutions to the specific embodiments of the present application without departing from the spirit and scope of the present application, and these modifications or equivalent substitutions shall fall within the protection scope of the claims of the present application.

What is claimed is:

1. A debris basket, applicable to a water surface cleaning robot and comprising:
a debris basket body (1) provided with a debris collection cavity (11) for accommodating debris, wherein a first end of the debris basket body (1) is provided with a water inlet (2) communicating with the debris collection cavity (11), and a second end of the debris basket body (1) opposite to the first end is provided with a plurality of water outlets (15) communicating with the debris collection cavity (11);
the debris basket body (1) is provided with a plurality of accommodating spaces (12) recessed toward the debris collection cavity (11); the plurality of accommodating spaces (12) are located on two sides of the water outlets (15) and are configured to accommodate driving mechanisms (7) of the water surface cleaning robot (1000); and
the water inlet (2), the debris collection cavity (11), and the water outlets (15) form a debris collecting water flow channel (S1); the accommodating spaces (12) form a propelling water flow channel (S2); and the debris collecting water flow channel (S1) and the propelling water flow channel (S2) are isolated from each other.

2. The debris basket according to claim 1, wherein the debris basket body (1) is provided, on two sides of the water inlet (2), with flanges (14) extending outwards obliquely.

3. The debris basket according to claim 1, wherein the debris basket body (1) is provided, on a bottom of the water inlet (2), with a scoop (13) extending obliquely toward a water surface.

4. The debris basket according to claim 1, further comprising a rolling brush (4) rotatably connected within the debris collection cavity (11) and located above the water inlet (2).

5. The debris basket according to claim 1, further comprising a handle (3) disposed within the debris collection cavity (11).

6. The debris basket according to claim 1, wherein a plurality of drainage holes

(16) are formed in a bottom of the debris collection cavity (11).

7. A debris basket, applicable to a water surface cleaning robot and comprising:
a debris basket body (1) provided with a debris collection cavity (11) for accommodating debris, wherein a first end of the debris basket body (1) is provided with a water inlet (2) communicating with the debris collection cavity (11), and a second end of the debris basket body (1) opposite to the first end is provided with a plurality of water outlets (15) communicating with the debris collection cavity (11);
the debris basket body (1) is divided into a first segment (17) and a second segment (19) along a direction from the water inlet (2) to the water outlets (15); the debris collection cavity (11) has a cross-sectional area at the first segment (17) larger than a cross-sectional area at the second segment (19) such that accommodating spaces (12) configured to accommodate driving mechanisms (7) of the water surface cleaning robot (1000) are formed on two sides of the second segment (19); and
the water inlet (2), the debris collection cavity (11), and the water outlets (15) form a debris collecting water flow channel (S1); the accommodating spaces (12) form a propelling water flow channel (S2); and the debris collecting water flow channel (S1) and the propelling water flow channel (S2) are isolated from each other.

8. The debris basket according to claim 7, wherein a transition segment (18) is further provided between the first segment (17) and the second segment (19); and along the direction from the water inlet (2) to the water outlets (15), the debris collection cavity (11) has a gradually decreasing cross-sectional area at the transition segment (18).

9. A water surface cleaning robot, comprising a robot body (200) and the debris basket (100) according to claim 1, wherein a mounting cavity (2001) is formed within the robot body (200), and the debris basket (100) is detachably mounted within the mounting cavity (2001).

10. A water surface cleaning robot, comprising a robot body (200) and the debris basket (100) according to claim 7, wherein a mounting cavity (2001) is formed within the robot body (200), and the debris basket (100) is detachably mounted within the mounting cavity (2001).

11. The water surface cleaning robot according to claim 9, further comprising a driving mechanism (7) that comprises a driving motor (5) and a propeller (6), wherein an output shaft of the driving motor (5) is connected to the propeller (6); and
after the debris basket (100) is mounted within the mounting cavity (2001), the driving mechanism (7) is located within the accommodating spaces (12); and the output shaft of the driving motor (5) is higher than a bottom surface of the debris basket body (1) in a height direction.

12. The water surface cleaning robot according to claim 10, further comprising a driving mechanism (7) that comprises a driving motor (5) and a propeller (6), wherein an output shaft of the driving motor (5) is connected to the propeller (6); and
after the debris basket (100) is mounted within the mounting cavity (2001), the driving mechanism (7) is located within the accommodating spaces (12); and the output shaft of the driving motor (5) is higher than a bottom surface of the debris basket body (1) in a height direction.
